(19) United States
(12) Patent Application Publication
(10) Pub. No.: US 2009/0278406 A1
(43) Pub. Date: Nov. 12, 2009

(54) Portable Power Supply

(75) Inventor: Peter F. Hoffman, Avon, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: EVEREADY BATTERY COMPANY, INC., St. Louis, MO (US)

(21) Appl. No.: 12/506,554

(22) Filed: Jul. 21, 2009

Related U.S. Application Data
(63) Continuation of application No. PCT/US2008/052002, filed on Jan. 25, 2008.
(60) Provisional application No. 60/897,410, filed on Jan. 25, 2007.

(51) Int. Cl. H02J 9/00; H02J 7/34

(52) U.S. Cl. 307/66; 320/103

(57) ABSTRACT

A system includes a power device and an electronic device. The electronic device includes a rechargeable power source and device electrical circuitry. The power device supplies power to the rechargeable power source according to at least one of a charging mode, an extended use mode, and a defined energy mode.

The present application is a continuation of International Application PCT/U.S. 2008/052002 entitled “Portable Power Supply” and is hereby incorporated by reference, which claims the benefit of U.S. Provisional Patent Application Ser. No. 60/897,410 filed Jan. 25, 2007.

### BACKGROUND OF THE INVENTION

This invention is related generally to electronic devices and, more specifically, to devices and methods related to supplying power to electronic devices.

The proliferation of portable battery powered devices, such as cellular telephones, has increased dramatically in the last several years and this trend is expected to continue. The phones typically use a rechargeable battery that is built into the phone to provide the needed power. The length of time that the battery powers the phone is dependent primarily upon the size of the battery and the number of energy consuming features built into the phone. In response to consumer demand, cell phone manufacturers incorporate into the phones features such as the ability to send and receive digital pictures and/or text messages. Unfortunately, the inclusion of these features usually places additional demands on the rechargeable batteries that power the cell phones. The net result is that the cell phones' run times become shorter and shorter due to the increased power demands. At the same time that the electrical demand placed on the battery is increasing, the size and weight of cell phones is decreasing in order to reduce the size of the phones. As the size of the cell phone is reduced, the size of the battery compartment built into the cell phone is also reduced. The existence of these two trends (i.e. increased electrical demand and reduced battery size) has caused many cell phone users to experience a failed telephone call or data transmission due to the depletion of their phone's battery at an inopportune moment. An additional trend that complicates resolving this problem is that most cell phones require a battery that has specific size and shape characteristics. In order to encourage consumers to purchase replacement batteries from the cell phone manufacturer, the cell phones are made with batteries that have unique shapes, locking mechanisms, voltage requirements, etc. Furthermore, the recharging port built into the cell phones can limit the type of charger that can be connected to the cell phone. Collectively, these factors limit the consumer's ability to rapidly replace the depleted battery with another power supply.

### BRIEF SUMMARY OF THE INVENTION

Embodiments of the present invention externally provide power to electronic devices. As a result, electronic devices can be operated for periods that extend beyond the limits of internal batteries.

In accordance with one embodiment of the invention, an external power device is disclosed. The device includes a battery compartment for holding one or more battery cells and circuitry that obtains power from the battery compartment and provides power to, for example, an electronic device, at a selected voltage level and current.

Other systems, methods, and devices are disclosed.

### BRIEF DESCRIPTION OF THE DRAWINGS

FIG. 1 is a block diagram of a system 100 for externally supplying power in accordance with an embodiment of the invention.

FIG. 2 is a block diagram of supply circuitry in accordance with an embodiment of the invention.

FIG. 3 is a chart illustrating energy density of various battery chemistries.

FIG. 4 is a chart illustrating specific capacity of various battery chemistries.

FIGS. 5A, 5B, and 5C are a circuit diagram illustrating supply circuitry.

FIG. 6 depicts an apparatus that includes a power device and an electronic device.

FIG. 7 depicts aspects of a user interface.

FIG. 8 depicts aspects of a user interface.

FIG. 9 depicts a method.

### DETAILED DESCRIPTION OF THE INVENTION

Embodiments of the present invention facilitate electronic device operation by providing externally supplied power. As a result, electronic devices can be operated for extended periods of time, which exceed limitations of internal batteries.

A function or use of an external power device is to recharge an internal power supply, such as an embedded Li Ion battery in an electronic device. This present invention also includes providing supplemental power of a specific quantity and of specific voltage and current characteristics to extend the run time or use of the device without deliberately charging the internal battery of the device. This is accomplished by limiting the output characteristics (that is maximum current) of the external power device to a level that will cause proper connection to the device yet low enough to enable new sizes, shapes, types or chemistries of external power.

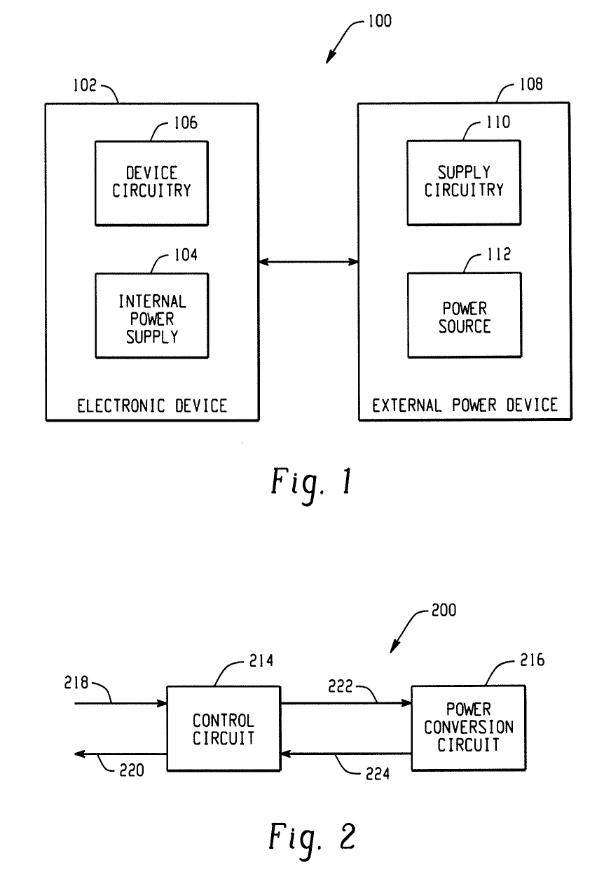

FIG. 1 is a block diagram of a system 100 for externally supplying power in accordance with an embodiment of the invention. The system 100 includes an electronic device 102 and an external power device 108.

The electronic device 102 includes device circuitry 106 and an internal power supply 104. The electronic device 102 includes a variety of devices such as, for example, portable electronic devices, non-portable electronic devices, cellular phones, personal digital assistants (PDA), notebook computers, smart phones, portable digital audio devices, multimedia devices, and the like. The electronic device 102, as an example can include a cellular or wireless phone that has features extending beyond making and receiving voice calls, such as the ability to send and receive digital pictures and/or text messages, browsing the Internet, listening to music, watching video content and performing other multi-media functions. It is noted that the above features typically increase power consumption and decrease run time.

The electronic device 102 can include other components not shown, for example, input/output devices, graphical displays, audio devices, recording components, text pads, touch screens, keyboards, headphone jacks, accessory interfaces (power and data), and the like. The device circuitry 106 controls and/or performs operation of the device. For example, the device 102 is a cell phone, the device circuitry 106 may control receiving and transmitting voice call information and the like. The device circuitry 106 typically operates on power received from the internal supply 104. Alternately, the device circuitry 106 can operate on power received from an alternate power source (not shown).

The internal power supply 104 supplies power to the device circuitry 106. The internal power supply 104 generally supplies the power at a voltage level and current that are suitable for operation of the device circuitry 106. The internal power supply 104, for example, can comprise one or more battery cells, including primary and/or secondary. The battery cells can be of a suitable chemistry, such as lithium ion, nickel metal hydride, and the like. In one example, rechargeable lithium ion batteries are employed in the internal power supply 104. Generally, lithium ion batteries provide higher current output than other battery types, such as alkaline batteries. The higher current output can be a requirement of the device circuitry 106.

The external power device 108 includes supply circuitry 110 and a power source 112. The power source 112 supplies power according to first characteristics including, but not limited to, voltage ranges, current ranges, peak voltages, peak currents, duration, and the like. The power source 112 can, for example, include one or more battery cells, including primary and/or secondary cells, fuel cells, solar cells, photo voltaic cells, crank dynamos, and the like. The battery cells can be of a suitable chemistry, such as nickel metal hydride, alkaline, lithium, zinc-air-prismatic (ZAP), and the like.

Various suitable chemistries can be employed for the one or more battery cells, as stated above. The various chemistries have properties including nominal voltage per cell, specific energy Wh/kg, g/Ah, Ah/kg, rate capabilities, and the like. For example, AA sized alkaline batteries and AA sized lithium batteries (LiFeS₂) have rate capabilities of about 1000 mW. Zinc air prismatic batteries having similar volumes as AA sized batteries have rate capabilities of about 500 mW.

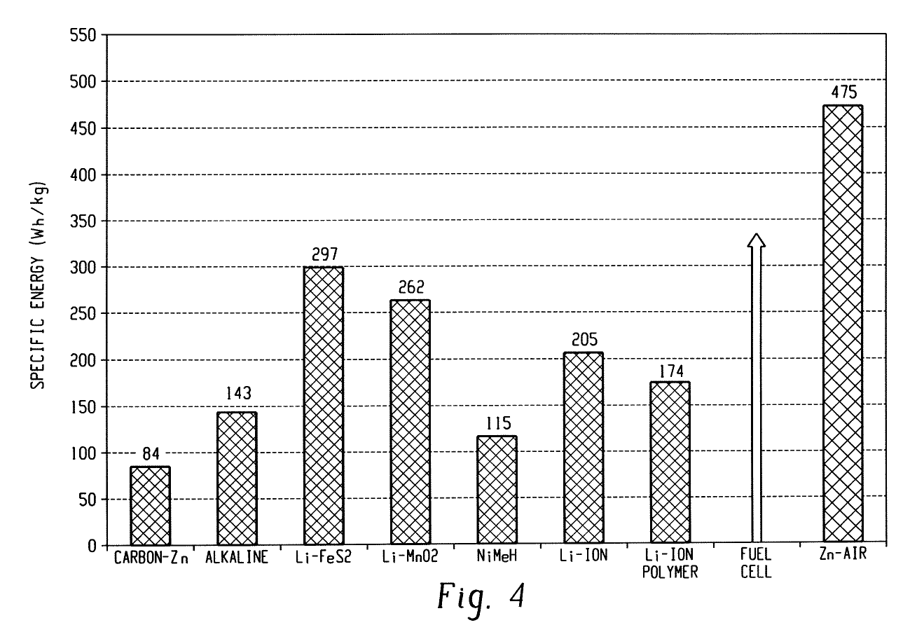

FIG. 3 is a chart illustrating energy density of examples of various battery chemistries that can be employed in the present invention. It will be understood that the Carbon-Zn, Alkaline, Li-FeS2, and Li-MnO2 chemistries are primary systems, the NiMeH, Li-Ion, Li-ion polymer chemistries are secondary chemistries, and that the fuel cell and Zn-Air chemistry represent promising new concepts. It is noted that zinc air prismatic provides an energy density of more than twice that of alkaline.

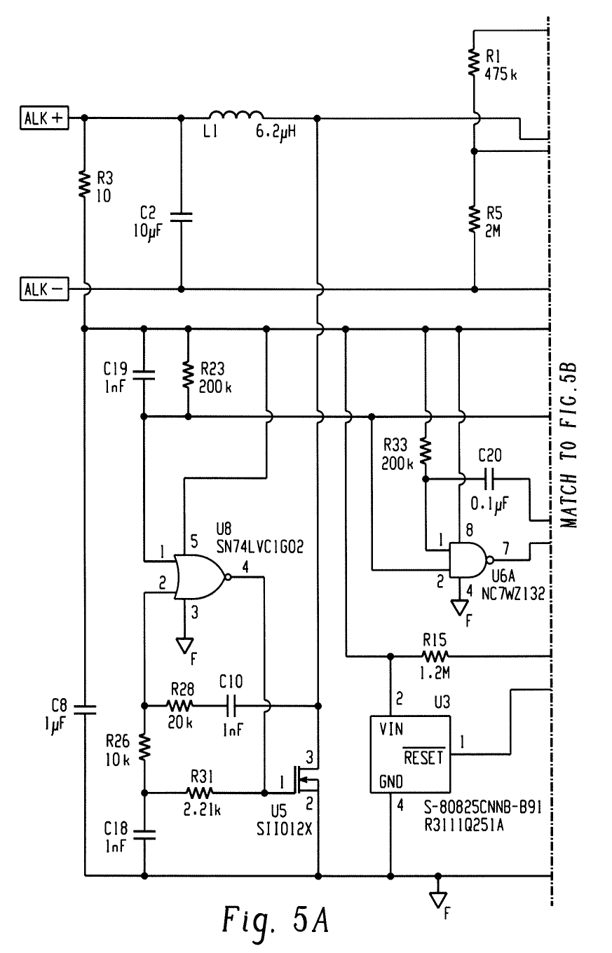

FIG. 4 is a chart illustrating specific capacity of examples of various battery chemistries that can be employed in the present invention. It is noted that zinc air provides a capacity over three (3) times greater than that of alkaline. It is also noted that fuel cells are estimated at 1000 Wh/kg with a run time of one hundred plus (100+) hours.

The supply circuitry 110 receives the power from the power source 112 and provides converted power according to second characteristics including, but not limited to, voltage ranges, current ranges, peak voltages, peak currents, duration, and the like. The second characteristics are generally associated with requirements of the electronic device 102. In one example, the second characteristics include providing current at a higher rate than the first characteristics. In another example, the supply circuitry 110 provides the converted power with second characteristics that include higher voltage and current than that of the first characteristics.

The second characteristics of the converted power can vary according to one or more modes of operation. For example, a charge mode of operation may supply the converted power with relatively high current to facilitate charging. As another example, an extended use mode of operation may supply the converted power with a relatively low current and/or limited duration so as to permit operation of the device 102 but refrain from charging the internal supply 104. As yet another example, a periodic mode may supply power periodically for a limited duration.

In one example, an external power device 108 employing two AA alkaline battery cells as the power source 112 is capable of providing 680 mA, but is limited to a lower level of 125 mA. The 680 mA may be required for the charge mode, but only 125 mA for the extended use mode. The lower power level reduces the load on the two AA alkaline battery cells from 2.5 W to 0.5 W while providing sufficient power for operation of electronic devices, such as those in compliance with the Nokia 2-mm DC Charging Interface specification, which can be found at:

http://sw.nokia.com/id/3378ff2b-4016-42b9-9118-d59e4313a521/Nokia_{—}2-mm_DC_Charging_Interface_Specification_v1_{—}2_en.pdf

The reduced load, which in the above example is reduced by a factor of five, allows for a longer duration of use for such an external power device 108.

In another example, a carbon zinc AA sized battery is employed as the power source 112 instead of alkaline cell(s). Carbon zinc cells are typically lower cost than alkaline cells and can be suitable for use in the extended mode.

In yet another example, zinc air batteries can be employed as the power source 112. Their greater energy density and specific capacity can allow for lighter and reduced volume requirements for the external power device 108 than is possible with other chemistries as shown in FIGS. 3 and 4.

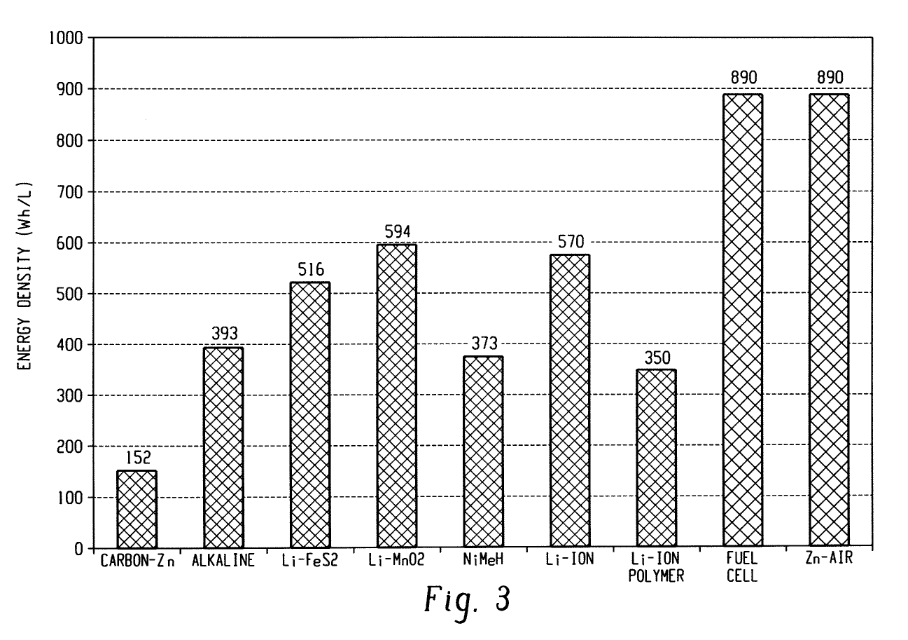

FIG. 2 is a block diagram of supply circuitry 200 in accordance with an embodiment of the invention. The supply circuitry 200 receives power according to first characteristics or power source characteristics and provides power according to second characteristics or selected output characteristics.

Generally, the supply circuitry 200 adjusts output of a power conversion device according to power source characteristics, application or mode of use, and the like. The power source characteristics include operating voltage, current output, power output, and the like. The application or mode of use can include power requirements for an external device, expected use, and the like as the selected output characteristics.

The supply circuitry 200 includes a control circuit 214 and a power conversion circuit 216. The control circuit 214 receives the non-converted power 218, for example, from a primary battery and provides converted power 220 according to the selected output characteristics. The control circuit 214 can modify properties of the non-converted power 218 and/or directly transfer the power 222 to the power conversion unit 216. Additionally, the control circuit 214 can modify properties of the converted power 224 from the power conversion unit 216 and/or direct transfer the converted power 224 as the power out 220. Additionally, the control circuit 214 controls and directs operation of the power conversion circuit 216. The control circuit 214 adjusts inputs of and/or communicates with the power conversion circuit 216 according to power source characteristics and the selected output characteristics. For example, the control circuit 214 can adjust the inputs according to an open circuit voltage of a particular chemistry employed as a power source. As another example, the control circuit 214 can adjust the inputs and/or communicate according to an extended use power limit, such as 50 mW/h.

Generally, the power conversion unit 216 converts input power to output power according to inputs and/or communicated information. The power conversion circuit 216 converts the input power 222 to the output power 224 according to one or more control inputs and/or communicated information. An example of a suitable power conversion device is the TEC103 DC-DC converter and charge controller integrated circuit available from Techtium Ltd. of Tel Aviv, Israel (www. techtium.com). However, other suitable power conversion units can be employed.

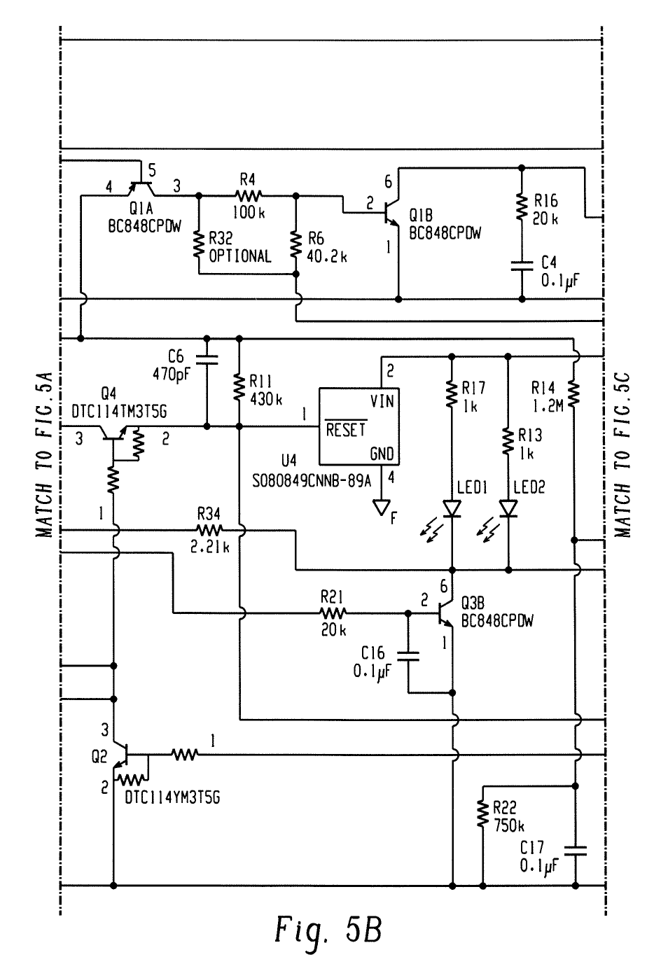

FIGS. 5A, 5B, and 5C are a circuit diagram illustrating an example of supply circuitry that can be employed in accordance with the present invention. Generally, supply circuitry adjusts outputs of a power conversion device according to the power source characteristics, application or mode of use, and the like. The power source characteristics include operating voltage, current output, power output, and the like. The application or mode of use can include power requirements for an external device, expected use, and the like.

The circuit in FIGS. 5A-C is an example that illustrates employing a TEC103 as a power conversion device within supply circuitry. It should be noted that other circuits and/or other power conversion devices can be used in place of the TEC103. Referring to FIGS. 5A-C, various external components are used to configure operating parameters of a power conversion circuit. Example modifications of the circuit shown enable it to operate from ZAP batteries. Changes include raising the value of R7 from 0.082 ohms to a value of 0.30 ohms, in one example. Raising the value of R7 lowers the overall maximum output current for the supply circuit. Note that R7 in FIG. 5C corresponds to Rsensel in the TEC103 datasheet. Lowering the output current enables the ZAP batteries to supply energy at a relatively low current in a use extending manner whereas running at higher output currents will exceed the ZAP batteries' capability. Adjustment of other components is also contemplated in order to facilitate power conversion efficiency for a specific application. Changes contemplated include changes to the inductor L1 and or other timing and filtering components such as Rt, Cin and Cout. A second change to a power conversion circuit can account for the slightly lower operating voltage of the ZAP battery chemistry relative to Alkaline, LiFeS2 or other nominally 1.5V battery systems. Other possible changes to FIGS. 5A-C include modification of the voltage divider comprised by R14 and R22 providing a signal to the Valk pin of the TEC103. In one such modification R22 was changed from a value of 750 kohms to 1.2 Mohms thus making the voltage signal present to Valk to be higher than it otherwise would have been thus making a compensation for the lower operating voltage of ZAP batteries. Other changes to the circuit in FIGS. 5A-C are also contemplated including changing startup parameters to enable the ZAP batteries to perform reliably under a relatively high demand during startup.

It is appreciated that other supply circuits are contemplated and include accommodating the other suitable battery chemistries as power source in accordance with alternate embodiments of the invention.

Other changes are also contemplated as well as the use of other power conditioning controllers.

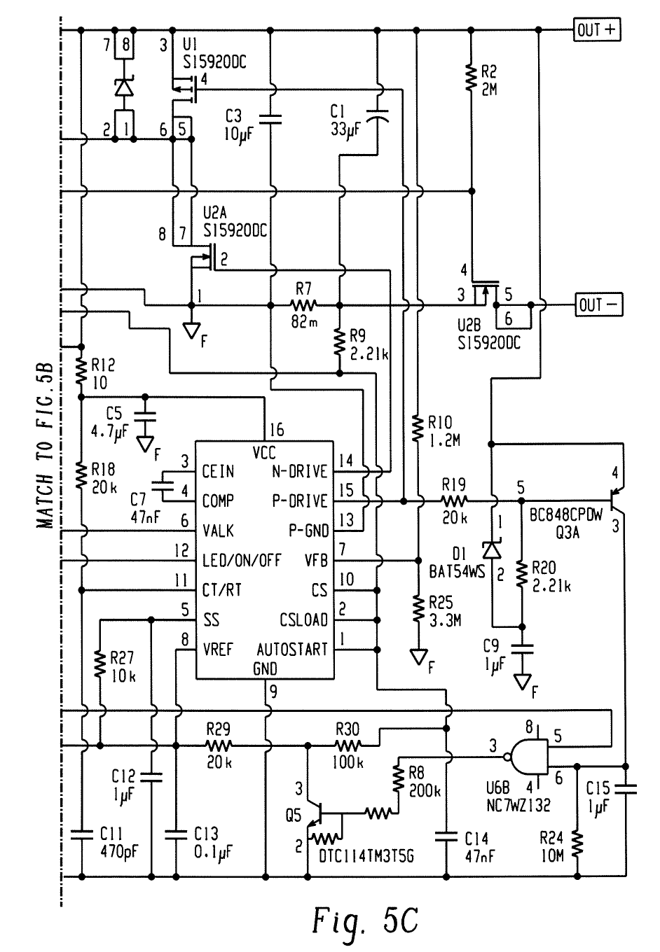

Turning now to FIG. 6, an apparatus 600 includes a portable power device 602 and a portable electronic device 604 The portable electronic device 604 is configured to be routinely operated when disconnected from a fixed power source such as the AC power mains or a vehicular electrical system. Example electrical devices 604 include but are not limited to consumer, commercial, and industrial electrical and electronic devices such as those described above in connection with electronic device 102, flashlights or other light sources, optical and other scanners or readers such as portable bar code scanners, and electrical or environmental measurement equipment such as voltmeters, ammeters, thermometers, and the like.

The electronic device 604 includes a housing 606 which, as illustrated, houses an electrical connector 608, a rechargeable power source 610, and device electrical circuitry 614.

The rechargeable power source 610, which is configured for electrical power communication with the connector 608, includes an energy storage device or devices such as one or more secondary (rechargeable) batteries, super capacitors or other capacitive energy storage devices, or other power sources such as those described above in connection with the power source 112.

The device electrical circuitry 614, which is likewise in electrical power communication with the rechargeable power source 610, uses power from the power source 610 to perform a function of the electronic device 604. The nature of the circuitry 614, as well as its voltage, current, and electrical power requirements, ordinarily depends on the nature and function of the device 604. Likewise, the nature and capabilities of the rechargeable power source 610 ordinarily depend on the device 604 and the needs of the circuitry 614. Note that the device electrical circuitry 614 may include a power converter that converts output of the power source 610 to the voltage and/or or current level(s) required by the circuitry 614.

Power for recharging the rechargeable power source 610 is provided via the electrical connector 608. Note that recharging circuitry may be interposed between the connector 608 and the rechargeable power source 610 to control recharging of the power source 610. The connector 608 may also provide signal or other connections between the device electrical circuitry 614 and other external devices.

The rechargeable power source 610 is ordinarily charged using an external power source 612 such as a conventional power cube that receives power from a fixed power source such as the AC power mains, an adaptor that receives power from a vehicular electrical system, or the like. When operated portably, the device 604 is ordinarily disconnected from the power source 612, in which case the device electrical circuitry 614 receives operating power from the rechargeable power source 610. Of course, the device 604 use time is limited by the energy storage capacity of the rechargeable power source 610.

With continuing reference to FIG. 6, the power device 602 includes a housing 624 that houses a power source receiving region 626, a power supply 618, a controller 622, a user interface 620, and an electrical connector 650.

The device 602 is preferably of a size and shape so as to be readily human-portable. For example, the form factor of the housing 624 may be such that the device 602 is readily carried by hand or placed in a pocket, purse, backpack, domestic or desk drawer, automobile glove box, or the like. Suitable form factors include the known Energi To Go™ and Energi To GO™ for ipod devices available from Energizer Corporation of St. Louis, Mo., USA.

The power source receiving region 626 receives a power source 616. The power source may include power source(s) such as one or more of primary (single use) or secondary batteries, capacitive energy storage devices, solar cells, hand cranks, or the like, with suitable devices and chemistries including those described above in connection with the power source 112. In one implementation, the power source receiving region 626 is accessed via a removable cover so that the user can readily inert fresh batteries or other power sources in and/or remove spent batteries or other power sources from the power source receiving region 626 as desired. Hence, when operated portably, the power device 602 is ordinarily not connected to a fixed power source.

The power supply 618 receives power from the power source 616 and produces a power supply output having voltage, current, and/or power levels required by the electronic device 604.

The controller 622 controls an operation of the power supply 618. As illustrated, the controller 622 causes the power supply 618 to operate in one or more of a charging mode 630, an extended use mode 632, and a defined energy mode 634. In this regard, it will be noted that the controller 622 need not be a discrete or separate controller and may integrated with the power supply 618.

When operated in the charging mode 630, the controller 622 causes the power supply 618 to supply energy to the electronic device 604/rechargeable power source 610 at a relatively high rate (e.g., at a relatively high power or current level) to facilitate charging of the rechargeable power source 610. Preferably, the power level is sufficient to also provide operating power to the device electrical circuitry 614 in situations where the rechargeable power source 610 is partially or substantially discharged. Such an arrangement can be expressed as follows:

### Equation 1

P_{Power Device}=P_{Device Electrical Circuitry}+P_{Charging}

where P_{Power Device} is the power supplied by the power device 602, P_{Device Electrical Circuitry} is the power drawn by the device electrical circuitry 614, and P_{Charging} is the power for charging the rechargeable power source 610. When operated in the charging mode 630, power may be provided to the electronic device 604 until the rechargeable power source 610 is substantially fully charged or otherwise reaches a desired state of charge. Once the rechargeable power source 610 has been charged as desired, the power device 602 may be disconnected from the electronic device 604 and the electronic device 604 operated using power from the rechargeable power source 610.

The charging mode 630 may be used to supplant or supplement the use of the external power source 612. Assume, for example, that the electronic device includes a mobile phone and that the rechargeable power source 610 is at least partially discharged. However, the user is traveling or otherwise unable to use the external power source 612 but would nonetheless like to ensure that the rechargeable power source 610 is suitably charged. The user connects the power device 602 and the electronic device 604 via the respective connectors 608, 650. The power device 602 supplies energy for charging the rechargeable power source 610. Note that, as described, the user may operate the electronic device 604 during the charging process. Once the desired charge has been imparted to the rechargeable power source 610, the user may disconnect the power device 602 from the electronic device 604.

While such an approach can be effective, the relatively higher drain rates needed to supply both charging energy to the rechargeable power source 610 and operating power to the device electrical circuitry 614 can deleteriously affect the lifetime of the power source 616. Moreover, the number of charging cycles that can be obtained before depleting the power source 616 may be somewhat limited.

When operated in the extended use mode 632, the controller 622 causes the power supply 618 to operate so that the temporal average of the power supplied by the power supply 618 is approximately equal to the temporal average of the power drawn by device electrical circuitry 614 and hence avoids deliberately charging the rechargeable power source 610:

### Equation 2

### P_{Power Device}≈P_{Device Electrical Circuitry}

Such an approach provides operating power to the device electrical circuitry 614 but refrains from substantially charging or discharging the rechargeable power source 610. Stated another way, the power provided by the power device 602 and the power drawn by the device electrical circuitry 614 are in equilibrium. Such an approach may be exploited to extend the operating time of the electronic device 604 while reducing the power drawn from the power source 616 relative to that drawn if the power device 602 were to be operated in the charging mode 630.

Again to the example of a mobile phone, assume that the rechargeable power source 610 is at least partially discharged. The user may wish to use the phone while away from his or her office during a lunch hour or while running an errand, but may be concerned about missing an important call. The user connects the power device 602 and the electronic device 604 via the respective connectors 608, 650. The power device 602 supplies power for maintaining the approximate state of charge of the rechargeable power source 610. Once the errand has been completed or the user again has access to the external power source 612, the user may disconnect the power device 602 from the electronic device 604.

In this sense, it should be understood that the power supplied by the power device 602 and the power drawn by the electronic device 604 need not be in exact equilibrium. Preferably, however, the rechargeable power source 610 is not substantially charged or discharged during those time periods in which the user is expected to “bridge the gap” in the course of ordinary usage.

The extended use mode 632 may be implemented in various ways. In a continuous power mode, power is supplied to the electronic device 604 on a continuous basis, with the temporal average of the supplied power being approximately equal to the temporal average of the power drawn by the device electrical circuitry 614, again according to an expected ordinary usage. In a discontinuous power mode, power may be supplied periodically or otherwise from time-to-time for a limited duration. Thus, the instantaneous power supplied by the power device 602 may be greater than that drawn by the device electrical circuitry 614, with the power being supplied at a reduced duty cycle:

### Equation 3

Duty Cycle·P_{Power Device Instantaneous}≈P_{Device Electrical Circuitry Average}

where 0<Duty Cycle<100%, P_{Power Device Instantaneous} is the instantaneous power supplied by the power device 602, and P_{Device Electrical Circuitry Average} is the time average of the power drawn by the device electrical circuitry 614.

Note that, in general, a more accurate equilibrium may be achieved by employing a current sense resistor or other sensor to measure the power supplied to the device or by sensing or otherwise determining an operating power drawn by the device electrical circuitry 614.

When operated in the defined energy mode 634, the controller 622 causes the power supply 618 to supply a defined amount or quantum of energy to the electronic device 604.

In one implementation, the amount of energy is defined in relation to the energy storage capacity of the power source 616. Thus, the amount or quantum of energy may be selected so that the power source 616 can be expected to supply the electronic device 604 a defined number of times before becoming discharged. For example, the energy quantum may be selected so that the power source 616 can be used to supply the electronic device 604 between about five (5) and twenty (20) times before becoming discharged. Even more preferably, the energy quantum may be selected so that the power source 616 can be expected to supply the electronic device 604 between about seven (7) and ten (10) times before becoming discharged.

In this regard, it will be understood that the number of usage cycles need not be established with absolute precision. It may be sufficient, for example, to provide the user with a general expectation or understanding of the number of uses to be expected from the power source 616 before it becomes depleted.

As the storage capacity of the power source 616 may be strongly affected by the discharge rate (e.g., in the case of certain battery technologies such as carbon zinc and to a lesser degree alkaline), operation in the extended use mode 632 can be expected to extend the life of the batteries. The extended use mode 632 may also be exploited to increase the application range of power sources 616 having a relatively limited rate capability (e.g., carbon zinc or zinc air batteries).

Additionally or alternately, the amount or quantum of energy and the energy storage capacity of the power source 616 may be established in relation to the energy storage capacity of the rechargeable power source 610. Thus, the quantum may be selected to correspond to an approximate percentage of the of the energy storage capacity of the rechargeable storage device 610. For example, the energy quantum may be selected to correspond to between about ten percent (10%) and twenty five percent (25%) of the capacity of the rechargeable energy storage device 610.

Thus, in one example embodiment, the user may have the general expectation that he or she can add about one (1) bar or charge to a mobile phone about seven (7) to ten (10) times before it is necessary to replace or recharge the power source 616.

Again, the percentage need not be established with absolute precision. It may be sufficient, for example, to provide the user with a general expectation or understanding that the power device 602 will supply in the neighborhood “one out of four or five bars” of charge.

The defined energy mode 634 may be implemented in various ways. In a time-based implementation, energy is supplied to the electronic device 604 for a defined amount of time. Hence, the controller 622 may include a timer 642 and/or a connection detector 644. The timer 642 may include a digital or analog timer or counter circuit, a resistor-capacitor (RC) network, or the like; the connection detector 644 may include a current, voltage or power sensor, a mechanical connection sensor, or the like. Timing is initiated in response to a detected, and the measured time is compared to a desired time period. Upon expiry of the time period, the controller 622 causes the power supply to terminate the supply of power to the electronic device 604 via a suitable shutdown circuit 628 such as a semiconductor or electromechanical switch or other suitable power supply shutdown circuit.

In a monitored-energy implementation, the energy supplied to the electronic device 604 is measured or otherwise monitored, for example according to a Coulomb counting technique in which the time integral of the current supplied to the electronic device is calculated. The supplied energy is compared to the desired value, with the supply of power being terminated accordingly. Note that combined time-based and monitored-energy implementations are also possible. Still other implementations, including those that take into account factors such as the rate at which energy is supplied to the electronic device 610, are also contemplated.

Note that the defined energy mode 634 may be implemented in conjunction with the charging mode 630 or the extended use mode 632.

Again to the example of a mobile phone, assume that the rechargeable energy source 610 is at least partially discharged. The user connects the power device 602 and the electronic device 604 via the respective connectors 608, 650. The power device 602 supplies the desired energy to the electronic device 604. If operated in conjunction with the charging mode 630, energy is supplied until the desired amount of energy has been delivered. If operated in conjunction with the extended use mode 632, approximate state of charge of the rechargeable power source 610 will be maintained. Once the desired amount of energy has been supplied, the supply of power is terminated, even though the user may neglect to disconnect the power device 602 from the electronic device. Of course, the user may also disconnect the power device 602 from the electronic device 604 as desired.

The optional user interface 620 allows the user to vary the operation of the power device 602 and/or provides the user with operational information. For example, the user interface may include buttons or switches that allow the user to initiate or terminate the supply of power to the device 604. Where the power device supports more than one of the modes 630, 632, 634, the user interface 620 may also include a mode selector switch or other input that allows the user to select among the supported modes. Additionally or alternatively, the user interface may include a display or other indicator that indicates that the power device 602 is supplying power to the electronic device 604 and/or the selected mode 630, 632, 634.

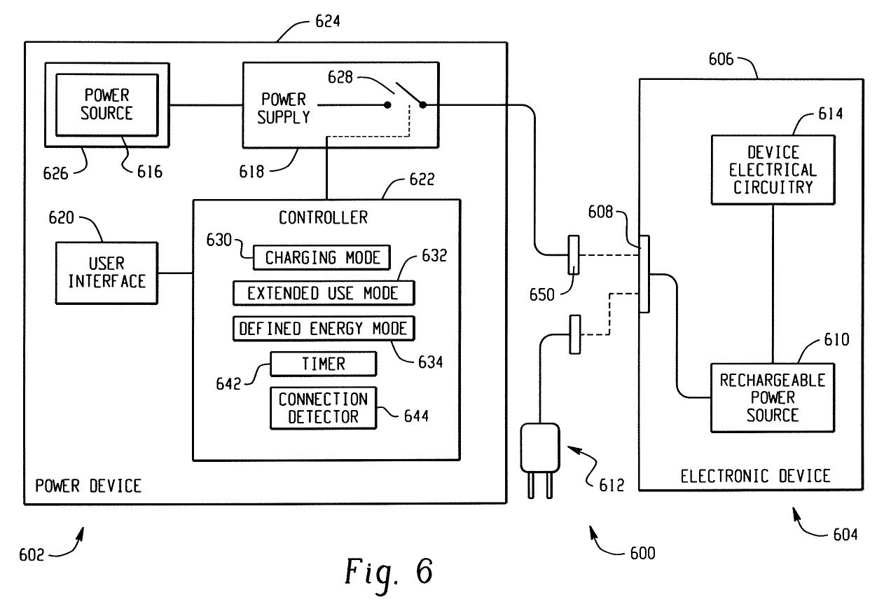

A user interface implementation that is particularly well-suited to use with power devices that support the defined energy mode 634 will now be described in relation to FIG. 7. As illustrated, the user interface includes energy variation buttons or switches 702, 704 and a user perceptible display or indicator 706. As illustrated in FIG. 7, the energy variation switches 702, 704 are implemented as momentary pushbuttons, for example via conventional membrane or pushbutton switches. Depressing or activating the energy increase switch 702 increases the desired energy, while depressing or activating the energy increase switch decreases the desired energy. In one implementation, the indicator 706 is incremented or decremented in response to the activation of the respective switches 702, 704 to indicate the current setting of the defined energy value. In the case of a time-based implementation, the display may also indicate an approximate desired connection time (e.g., 10, 20, or 30 minutes). In another, the indicator 706 provides information indicative of an approximate number of usage cycles remaining until the power source 616 becomes discharged. This may be accomplished by incrementing (or decrementing) the display for each usage cycle.

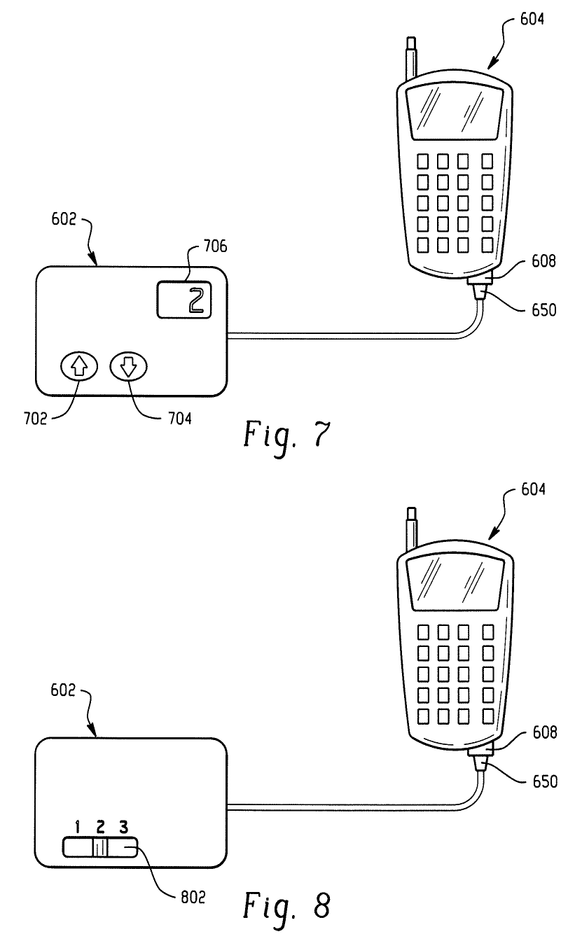

Note that variations of the user interface are contemplated. For example, one of the switches 702, 704 may be eliminated. In another, and as illustrated in FIG. 8, an energy variation switch 802 may be implemented as a slide or other switch, the position of which is used to select the desired amount of energy. Note that, as illustrated, the display 706 may be eliminated. Indeed, the energy variation switches 702, 704, 802 may also be eliminated.

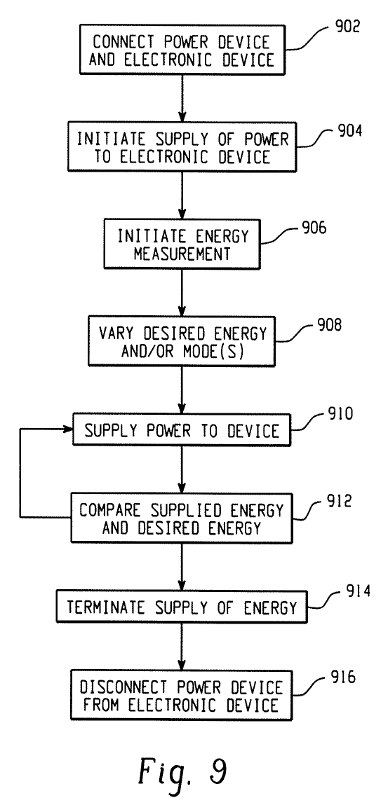

Operation of the system will now be described in relation to FIG. 9.

At 902, the user connects the power device 602 and the electronic device 604. As described above, for example, the connection may be provided through the devices' respective electrical connectors 650, 608.

The supply of power from the power device 602 to the electronic device 604 is initiated at 904. In one implementation, the initiation is performed automatically in response to a detected connection of the devices. Where supported by the user interface 620, the supply of power may be initiated in response to an input from the user. Depending on the functionality supported by the power device 602, power may be supplied according to the charging 630 or extended use 632 modes. Note that power may also be supplied at a rate that is relatively lower than that drawn by device electrical circuitry 614, in which case the rechargeable power source would gradually become depleted, albeit more slowly than if the power device 602 was not used.

In the case of a power device 602 that supports the defined energy mode 634, measurement of the supplied energy is initiated at 906, for example via a time-based, monitored energy, or other implementation.

Where supported by the power device 602, the desired energy and/or mode(s) may be varied at 908, for example via the user interface 620. Note that the desired energy and/or mode(s) may also be varied via a signal from the electronic device 604. It will also be appreciated that the desired energy and/or mode(s) may be varied at other points in the process, for example before or after step 902.

Power is supplied to the device at 910.

Again in the case of a power device 602 that supports the defined energy mode 634, the supplied energy and the desired energy are compared at 912. Where the desired energy has not been delivered, the process continues at 910.

If the desired energy has been delivered, the supply of power is terminated at 914. Note that, where supported, the supply of power may be terminated via the user interface 620 or otherwise via a signal from the electronic device 604.

At 916, the user disconnects the power device 602 from the electronic device 604 as desired.

As will be appreciated, the user may also operate the electronic device 604 as desired during the various steps in the process.

Note that, while the power device 602 has been described as an external device, it may also be internal to or otherwise form a part of the electronic device 604.

The invention has been described with reference to the preferred embodiments. Of course, modifications and alterations will occur to others upon reading and understanding the preceding description. It is intended that the invention be construed as including all such modifications and alterations insofar as they come within the scope of the appended claims and their equivalents.

What is claimed is:

1. An apparatus comprising:
a device that includes a first rechargeable power source and device electrical circuitry in power communication with the rechargeable power source;
a power source receiving region;
a power supply that receives power from a second power source received in the receiving region and supplies power to the device; and
a controller that controls operation of the power supply and causes the power supply to operate according to a first extended use mode.

2. The apparatus of claim 1, wherein the first extended use mode include wherein the power supplied by the power supply and an operating power drawn by the device electrical circuitry are in equilibrium.

3. The apparatus of claim 2, wherein the first extended use mode further includes wherein a state of charge of the first rechargeable power source is substantially unchanged.

4. The apparatus of claim 1 wherein the power supply supplies power to the device according to a second charging mode in which the temporal average of the power supplied by the power supply is greater than the temporal average of the operating power drawn by the device electrical circuitry, wherein the rechargeable power source is charged using power from the second power source.

5. The apparatus of claim 1, wherein the controller causes the power supply to discontinue the supply of power to the device when a defined amount of energy has been supplied by the power supply.

6. The apparatus of claim 5, wherein the controller includes a timer that measures an elapsed time during which the power supply has supplied power to the device.

7. The apparatus of claim 1, further comprising a mechanism for limiting the average power supplied by the power supply to a level that is approximately equal to the average power drawn by the device electrical circuitry.

8. The apparatus of claim 1 wherein the power supply provides power to the device according to the relation:
Duty Cycle P_{Power Device Instantaneous}≈P_{Device Electrical Circuitry Average}

9. An apparatus comprising:
a portable device that includes a first rechargeable power source and device electrical circuitry;
a power device;
a power source receiving region within the power device;
a power supply within the power device that receives power from a second power source received in the receiving region and supplies power to the first rechargeable power source;
a controller within the power device that causes the power supply to supply power to the first rechargeable power source according to a defined energy mode in which the power supply supplies a defined amount of energy.

10. The apparatus of claim 9 wherein the controller causes the power supply to supply power to the rechargeable power source for a defined time period.

11. The apparatus of claim 10 including a timer that measures the time period.

12. The apparatus of claim 9 including a connector that removably electrically connects the power supply and the device and a connection detector that detects a connection between the power supply and the device, wherein the time period is initiated in response to a detected connection.

13. The apparatus of claim 9 including a user interface that allows the user to vary the time period.

14. The apparatus of claim 9 including a user interface that allows the user to define the amount of energy.

15. The apparatus of claim 14 wherein the user interface allows the user to initiate the supply of power from the power supply to the device.

16. The apparatus of claim 14 wherein the user interface includes an energy variation switch, the activation of which varies the defined amount of energy.

17. A method comprising:
providing a device that includes a first rechargeable power source and device electrical circuitry;
receiving power from a second power source;
using a power supply to supply power from the second power source to the device; and
during an operation of the device electrical circuitry, operating the power supply according to an extended use mode that maintains a state of equilibrium between the supplied power and an operating power drawn by the device electrical circuitry.

18. The method of claim 17 including using a controller to maintain the temporal average of the supplied power at a value that is approximately equal to the temporal average of the power drawn by the electrical circuitry.

19. The method of claim 18 wherein the controller includes a sensor that senses a current supplied to the device.

20. The method of claim 17 wherein the product of an instantaneous power supplied to the device and a duty cycle is approximately equal to an average power drawn by the device electrical circuitry.
